(19) United States
(12) Patent Application Publication
(10) Pub. No.: US 2015/0148473 A1
(43) Pub. Date: May 28, 2015

(54) APAO-based hot melt adhesives

(71) Applicant: RexTac LLC., Odessa, TX (US)

(72) Inventors: Andres Sustic, Odessa, TX (US); James Haselman, Odessa, TX (US); James Nicholas Fowler, Odessa, TX (US); Enrico L. Buenacosa, Odessa, TX (US)

(21) Appl. No.: 14/554,297

(22) Filed: Nov. 26, 2014

Related U.S. Application Data
(60) Provisional application No. 61/909,677, filed on Nov. 27, 2013.

(51) Int. Cl. C09J 123/20; C08K 5/01

(52) U.S. Cl. CPC C09J 123/20; C08K 5/01
USPC 524/505; 524/518

(57) ABSTRACT

Ethylene-co-propylene-co-butene-1 terpolymers, made either with or without an in-reactor-added organosilicon external donor, are used in the formulation of improved-performance, APAO-based, hot melt adhesives.

### CROSS-REFERENCE TO RELATED APPLICATIONS

This application claims the benefit of U.S. Provisional Application No. 61/909,677, filed on Nov. 27, 2013.

### STATEMENT REGARDING FEDERALLY SPONSORED RESEARCH OR DEVELOPMENT

Not Applicable

### BACKGROUND OF THE INVENTION

1. Field of the Invention

The present invention generally relates to formulations suitable for use as hot-melt adhesives. More particularly, it relates to APAO-based hot-melt adhesives.

2. Description of the Related Art Including Information Disclosed Under 37 CFR 1.97 and 1.98.

Amorphous poly-alpha-olefins (APAO) are produced by the (co-) polymerization of α-olefins, e.g. propylene or 1-butane with Ziegler-Natta catalysts. The (co-)polymers have an amorphous structure which makes them useful for the production of hot melt adhesives, either in neat or formulated form, and for other uses and applications in which the use of APAO may be advantageous.

U.S. Pat. No. 5,302,675, “High Tensile Strength Amorphous 1-Butene/Propylene Copolymers,” describes a process for the production of propylene/1-butane copolymers comprising: reacting propylene and 1-butene monomers in the presence of a catalyst system comprising: (a) a solid supported catalyst component is prepared by the method comprising: (i) co-comminuting magnesium halide support base and aluminum trihalide in a molar ratio from about 8:0.5 to about 8:3 in the absence of added electron donor; and (ii) then co-comminuting the product of step (i) in the absence of added electron donor with sufficient titanium tetrahalide to provide a molar ratio of magnesium halide to titanium tetrahalide from about 8:0.1 to about 8:1.0; (b) a trialkylaluminum co-catalyst, having from 1 to 9 carbon atoms in each alkyl group in an amount such that the Al/Ti ratio is between about 50:1 and about 500:1; (c) an alkoxy silane component of the formula Rₙ Si(OR′)₄₋ₙ where n=1-3, R=aryl or alkyl and R′=C₁₋₃ alkyl in a sufficient quantity such that the molar ratio of organoaluminum co-catalyst to alkoxy silane is in the range from about 20:1 to about 45:1. Said copolymer being characterized by a propylene content of 25 to 50 wt. %, a 1-butene content of 75 to 50 wt. % and a tensile strength of at least 300 psig.

U.S. Pat. Nos. 5,681,913, 5,637,665, and 5,714,554 each entitled “High Tensile Strength Amorphous 1-Butene/Propylene and Ethylene/Propylene Copolymers,” describe amorphous propylene/1-butene and ethylene/propylene copolymers having increased tensile properties produced by the process comprising: reacting propylene and 1-butene monomers or ethylene and propylene monomers in the presence of a catalyst system comprising: (a) a solid supported catalyst component is prepared by the method comprising: (i) co-comminuting magnesium halide support base and aluminum tri-halide in a molar ratio from about 8:0.5 to about 8:3 in the absence of added electron donor; and (ii) then co-comminuting the product of step (i) in the absence of added electron donor with sufficient titanium tetra-halide to provide a molar ratio of magnesium halide to titanium tetrahalide from about 8:0.1 to about 8:1.0; (b) a trialkylaluminum co-catalyst, having from 1 to 9 carbon atoms in each alkyl group in an amount such that the Al/Ti ratio is between about 50:1 and about 500:1; and (c) an alkoxy silane component of the formula Rₙ Si(OR′)₄₋ₙ where n=1-3, R=aryl or alkyl and R′=C₁₋₃ alkyl.

U.S. Pat. No. 6,586,543, “Process for the Preparation of Substantially Amorphous Poly-alpha-olefins,” describes a process for preparing a substantially amorphous poly-α-olefin, which includes: a) preforming a solid catalyst and, optionally, a first amount of a trialkylaluminum cocatalyst, by contacting the catalyst and optionally the cocatalyst with at least one selected from the group including oxygen and a compound which includes active oxygen, to form a preformed catalyst, wherein the solid catalyst includes magnesium, aluminum and titanium, and wherein said trialkylaluminum cocatalyst includes 1 to 9 carbon atoms in each alkyl group: b) contacting the preformed catalyst with a second amount of the cocatalyst, wherein a molar ratio of trialkylaluminum to the titanium ranges from 40:1 to 700:1, to form a catalyst mixture; c) polymerizing, in the liquid phase, with the catalyst mixture, an olefin or an olefin mixture at a temperature between 30 and 160° C., to produce the poly-α-olefin.

U.S. Pat. No. 4,309,522, “Process for the production of extensively amorphous butene-1-propene-ethene terpolymers having a high softening point,” describes a process for preparing an extensively amorphous butene-1-propene-ethene terpolymer having a high softening point that comprises low pressure solution polymerizing butene-1, propene and ethene by contacting these monomers with a catalytically effective amount of a mixed catalyst of a thermally unstable crystalline TiCl₃.0.30 to 0.35 AlCl and a trialkyl aluminum or dialkyl aluminum hydride, each having alkyl groups of 2-4 carbon atoms, the atomic ratio of Al:Ti being 0.8-4.0.

U.S. Pat. No. 4,322,514, “Process for preparing a copolymer,” describes a process for preparing a non- or low-crystalline soft copolymer, characterized in that 50 to 98 mole % of propylene, 0.2 to 30 mole % of ethylene and 0.2 to 45 mole % of a straight-chained α-olefin having not less than four carbon atoms are copolymerized using a catalyst, said catalyst comprising (1) a solid substance containing magnesium and titanium and (2) an organometallic compound.

U.S. Pat. No. 4,826,939, “Highly amorphous olefin terpolymer,” describes highly amorphous olefin terpolymers from propylene, 1-hexene, and ethylene in which the ethylene units are incorporated in the polymer chain in a highly random manner, and a process for producing such terpolymers.

### BRIEF SUMMARY OF THE INVENTION

Ethylene-co-propylene-co-butene-1 terpolymers, made either with or without an in-reactor-added organosilicon external donor, are used in the formulation of improved-performance APAO-based hot melt adhesives.

### DETAILED DESCRIPTION OF THE INVENTION

Due to the tri-compositional nature of ethylene-co-propylene-co-butene-1 terpolymer APAOs, each one of the co-monomers adds a unique set of properties to the APAO, not achievable from just the use of intra APAO blends of copolymers such as ethylene-propylene and propylene-butene-1. It has been found that this set of properties is enhanced, or changed, by the addition of an external organosilicon donor.

The use of these APAO terpolymers may add unique properties when used as components in such hot melt adhesive (HMA) formulations such as those used in personal hygiene products (e.g., diapers, feminine hygiene pads, adult incontinence garments, and the like), in case- and carton-sealing packaging, in assembly and other such applications that require such properties as controllable open time; quick set times; low temperature flexibility; good temperature resistance; moderate to high tensile strength and elongational properties; and, other such desirable properties.

An HMA according to the invention may comprise an ethylene-co-propylene-co-butene-1 terpolymer APAO with a 1-butene content of about 10%, more preferably, about 15%, much more preferably of about 20% and most preferably of about 25%.

The addition of another monomer component, ethylene, results in a terpolymer APAO, with an ethylene content of at least 5%, and up to as much as 20%; however, it should preferably have about 5 to 15% and most preferably 5 to 10%.

In addition, the inclusion of a so-called external donor of the organosilicon class, such as for example cyclohexylmethyl dimethoxy silane, (CMDMS), or phenyl triethoxysilane, (PES), imparts some unique characteristics to the physical and mechanical properties of the terpolymer, not achievable without the presence of the donor in the reaction medium, properties that may favorably affect the final performance of the hot melt adhesive containing it.

There are other co-adjuvants part of the subject HMA, such as tackifiers, preferably the type that is considered compatible with the APAO components. Such tackifiers are of the partially and fully hydrogenated C₅, hydrogenated C₅-C₉, and hydrogenated dicyclopentadiene-type resins but can be any other tackifier which by its chemical nature can be considered compatible with the APAO terpolymer.

Yet other components can be polyethylene, maleic anhydride grafted polyethylene, maleic anhydride grafted polypropylenes, Fischer-Tropsch, paraffinic waxes and metallocene waxes. These, as well as other similar compatible waxes, have the effect of controlling the melt viscosity and also controlling the rate of set of the HMA.

Also, so called liquid plasticizers such as mineral, paraffinic or naphthenic oils, liquid polybutenes and polybutylenes, may be used in the terpolymer-based formulation to add such properties as control of melt viscosity, tackiness and controllable open time and set time.

Also, components such as antioxidants and UV stabilizers may be added as co-adjuvants. Examples of other compatible polymers which may be included in the formulation of the subject HMA include: hydrogenated styrene block copolymers of the SEBS and SEPS type, EP rubbers, and polyethylenes such as LLDPE of melt indices (MI's) of typically more than about 500 dg/min.

Also used, preferable as the minor component, can be the so-called metallocene polyethylenes (which are known in the art as mPE's) and whose composition consists of ethylene copolymerized with such alpha-olefins as 1-butene or 1-hexene or 1-octene. Metallocene polypropylenes (also known as “mPP”) of the appropriate molecular weight so as to be compatible with the subject APAO terpolymer, may also be added as a minor component.

It has been found that the above-named co-adjuvants together with the long polymeric chains of the ethylene-propylene-butene APAO made in the presence of the externally added organosilicon, results in an HMA with a lower, yet desirable, melt viscosity which results in better wetting and penetration of various substrates (porous or non-porous), resulting in a greater degree of adhesive bonding. Also, the interaction of the multiple components results in a higher, yet controllable, tackiness for applications which demand a certain degree of tackiness, and also, a fast, preferably very fast, rate of set, typically less than 5 seconds, most preferably less than 2 seconds.

It has been found that the use of the ethylene-propylene-butane APAO made in the presence of the externally added organosilicon, when properly formulated with the above named co-adjuvants, at concentrations of from 0 up to about 25 wt. % of tackifier(s), or between 0 to about 15 wt. % of the above-mentioned wax(es), or between 0 and about 25 wt. % of the above-mentioned oil(s), results in a hot-melt adhesive that is superior to hot-melt adhesives not containing the aforementioned polymer.

Table 1, below, lists various formulations (2558-83-xx) developed, seven of which were tested against commonly used competitive HMAs.

TABLE 1

| | 2558-83- | | | | | | | | | | Techno | Advantra | Advantra |
|---|---|---|---|---|---|---|---|---|---|---|---|---|---|
| Material | 27 | -26 | -28 | -29 | -30 | -31 | -32 | -33 | -34 | -35 | Melt 2697 | PHC 7264 | PHC 9256 |
| Terpolymer | 75 | 75 | 70 | 70 | 75 | 70 | 75 | 60 | 65 | 75 | | | |
| Composite | | | | | | | | | | | | | |
| Wingtack ET | 10 | 10 | 15 | 10 | 15 | 20 | | | | | | | |
| C-105 Wax | 10 | 10 | 10 | 10 | 5 | 5 | 10 | 5 | 10 | 10 | | | |
| Honeywell AC-573 | 5 | | 5 | 10 | 5 | 5 | 5 | | 5 | | | | |
| Honeywell AC-596 | | 5 | | | | | | | | 5 | | | |
| Eastotac H130R | | | | | | | 10 | 15 | 10 | 10 | | | |
| RT6705 | | | | | | | | 20 | | | | | |
| RT2304 | | | | | | | | | 10 | | | | |
| | 100 | 100 | 100 | 100 | 100 | 100 | 100 | 100 | 100 | 100 | | | |
| Melt Visc. @ | 1587 | | | | | | 1670 | 1810 | 1440 | 1905 | 967 | 1192 | 878 |
| 350° F. | | | | | | | | | | | | | |
| Melt Visc. @ | 1150 | | 1022 | 990 | 1278 | 1175 | 1212 | 1282 | 1065 | 1467 | 623 | 850 | 635 |
| 375° F. | | | | | | | | | | | | | |
| Ring & Ball SP, | 251 | | | | | | | 252 | | 267 | | | |
| ° F. | | | | | | | | | | | | | |
| SAFT, ° F. | 219 +/− 5 | | | | | | | 220 +/− 4 | | | 172 +/− 4 | 169 +/− 5 | 193 +/− 8 |

NOTES:
Wingtack ET, from Cray Valley, is an aromatically modified C-5 hydrocarbon resin tackifier;
Eastotac H130R, from Eastman Chemical Co., is a hydrogenated aliphatic hydrocarbon resin,
C-105 wax, from Sasol Wax is a Fischer-Tropsch wax;
Honeywell AC-573 is a maleic anhydride grafted polyethylene wax;
Honeywell AC-596 is a maleic anhydride grafted polypropylene wax;
RT 2304 from REXtac, LLC, is a medium ethylene content APAO, and RT 6705 from REXtac, LLC, is a maleic anhydride grafted butene-1 APAO.

Table 2 and Table 3, below, present the results of Manual Fiber Tear Tests of laminates made using either virgin, uncoated or coated corrugated cardboard box flaps, bonded with various APAO-based hot melt adhesives prepared according to the present invention and three, commercially available HMAs of the prior art. The tables report the % Fiber Tear for each sample.

TABLE 2

| | | | Dwell | | | 24 hrs at 140° F. |
|---|---|---|---|---|---|---|
| | | Temperature, | Time, | 24 hrs RT Manual Peels, | 24 hrs freezer manual peels, | manual peels, |
| Sample Id | Substrate | ° F. | sec | % Fiber tear | % Fiber Tear | % Fiber Tear |
| Technomelt | Coated | 325 | 0.5 | 100, 100, 100, 100 | 0, 100, 30, 60 | 100, 100, 0, 40 |
| 2697 | corrugated | | 1 | 100, 0, 0, 30, 0 | 100, 0, 0, 0, 0 | 0, 0, 0, 0 |
| | cardboard | | 2 | 100, 100, 0, 100 | 0, 80, 100, 100, 60 | 0, 0, 0, 0 |
| | | 350 | 0.5 | 100, 100, 100, 100, 100 | 100, 100, 100, 100, 100, 100 | 100, 90, 90, 100, 100 |
| | | | 1 | 100, 0, 100, 100, 100 | 100, 100, 100, 100, 100 | 100, 100, 100, 100, 100 |
| | | | 2 | 100, 100, 100, 100, 100 | 100, 100, 100, 100, 100 | 100, 100, 100, 100, 100 |
| Advantra | Virgin | 325 | 0.5 | 100, 100, 100, 100, 100 | 100, 100, 100, 100, 100 | 100, 100, 100, 100, 100 |
| PHC 9256 | corrugated | | 1 | 100, 100, 100, 100, 100 | 100, 100, 100, 100, 100 | 100, 100, 100, 100, 100 |
| | cardboard | | 2 | 100, 100, 100, 100, 100 | 100, 100, 100, 100, 100 | 100, 100, 100, 100, 100 |
| | | 350 | 0.5 | 100, 100, 100, 100, 100 | 100, 100, 100, 100, 100 | 100, 100, 100, 100, 100 |
| | | | 1 | 100, 100, 100, 100, 100 | 100, 100, 100, 100, 100 | 100, 100, 100, 100, 100 |
| | | | 2 | 100, 100, 100, 100, 100 | 100, 100, 100, 100, 100 | 100, 100, 100, 100, 100 |
| Rextac | Coated | 325 | 0.5 | 90, 0, 90, 50, 100 | 100, 100, 100, 100, 100, 100 | 100, 100, 100, 100, 100, 100 |
| 2558-83-27 | corrugated | | 1 | 90, 100, 80, 100, 0 | 100, 100, 40, 20, 10, 10 | 100, 100, 100, 100, 100, 80 |
| | cardboard | | 2 | 80, 0, 90, 30, 0 | 20, 20, 50, 100, 40 | 40, 40, 100, 100, 100 |
| | | 350 | 0.5 | 100, 90, 90, 100, 10 | 100, 0, 0, 0, 10 | 100, 100, 100, 100, 100 |
| | | | 1 | 30, 100, 100, 100, 100 | 0, 10, 90, 50 | 100, 100, 100, 100, 100 |
| | | | 2 | 0, 20, 40, 10, 0 | 0, 50, 0, 0, 50 | 100, 100, 100, 100, 60 |
| Rextac | Virgin | 325 | 0.5 | 100, 100, 100, 100, 100 | 100, 100, 100, 100, 100 | 100, 100, 100, 100, 100 |
| 2558-83-26 | corrugated | | 1 | 100, 100, 100, 100, 100 | 100, 100, 100, 100, 100 | 100, 100, 100, 100, 100 |
| | cardboard | | 2 | 100, 100, 100, 100, 100 | 100, 100, 100, 100, 100 | 100, 100, 100, 100, 100 |
| | | 350 | 0.5 | 100, 100, 100, 100, 100 | 100, 100, 100, 100, 100 | 100, 100, 100, 100, 100 |
| | | | 1 | 100, 100, 100, 100, 100 | 100, 100, 100, 100, 100 | 100, 100, 100, 100, 100 |
| | | | 2 | 100, 100, 100, 100, 100 | 100, 100, 100, 100, 100 | 100, 100, 100, 100, 100 |

TABLE 3

| | | | | Dwell | | | |
|---|---|---|---|---|---|---|---|
| | | | Temp., | Time, | 24 hrs RT aged manual | 24 hrs freezer aged | 24 hrs at 140° F. aged |
| Sample Id | Composition, wt % | Substrate | ° F. | sec. | peels, % Fiber tear | manual peels, % Fiber tear | manual peels, % fiber tear |
| 2558-83-27 | Terpolymer, 75% | Coated | 325 | 1 | 80, 20, 0, 0, 0 | 5, 0, 5, 0, 0 | 100, 100, 0, 0, 0 |
| Control | Wingtack ET, 10% | corrugated | | 2 | 0, 20, 70, 0, 30 | 0, 0, 0, 0, 0 | 80, 5, 90, 0, 0 |
| | C-105, 10% | cardboard | 350 | 1 | 0, 90, 0, 0, 0 | 0, 0, 100, 0, 0 | 70, 0, 5, 50, 100 |
| | AC573, 5% | | | 2 | 0, 0, 0, 0, 5 | 100, 0, 0, 0, 0 | 100, 0, 0, 0, 0 |
| 2558-83-31 | Terpolymer, 70% | Coated | 325 | 1 | 60, 100, 100, 100, 5 | 50, 100, 100, 100, 10 | 100, 100, 90, 100, 10 |
| | WT ET, 20% | corrugated | | 2 | 100, 50, 100, 100, 100 | 100, 90, 100, 100, 100 | 100, 100, 100, 95, 100 |
| | C-105, 5% | cardboard | 350 | 1 | 100, 100, 70, 100, 70 | 80, 100, 80, 100, 100 | 100, 100, 90, 100, 100 |
| | AC573, 5% | | | 2 | 0, 100, 60, 80, 0 | 0, 100, 100, 100, 50 | 90, 90, 100, 50, 100, 60 |
| 2558-83-32 | Terpolymer, 75% | Coated | 325 | 1 | 0, 0, 0, 0, 0 | 5, 50, 0, 0, 0 | 100, 100, 90, 70, 0 |
| | H130R, 10% | corrugated | | 2 | 0, 0, 0, 0, 100 | 10, 0, 90, 100, 60 | 100, 100, 100, 0, 40 |
| | C-105, 10% | cardboard | 350 | 1 | 0, 20, 0, 50, 0 | 80, 20, 0, 50, 10 | 0, 100, 90, 100, 0 |
| | AC573, 5% | | | 2 | 0, 80, 0, 0, 5 | 0, 100, 90, 0, 0 | 50, 90, 100, 60, 5 |
| 2558-83-33 | Terpolymer, 60% | Coated | 325 | 1 | 100, 100, 100, 100, 100 | 100, 100, 100, 100, 100 | 100, 100, 100, 100, 100 |
| | H130R, 15% | corrugated | | 2 | 100, 100, 100, 100, 100 | 100, 100, 100, 100, 100 | 100, 100, 100, 100, 100 |
| | C-105, 5% | cardboard | 350 | 1 | 100, 100, 100, 100, 100 | 100, 100, 100, 100, 100 | 100, 100, 100, 100, 100 |
| | RT6705, 20% | | | 2 | 100, 100, 100, 100, 100 | 100, 100, 100, 100, 100 | 100, 100, 100, 100, 100 |
| 2558-83-34 | Terpolymer, 65% | Coated | 325 | 1 | 100, 100, 50, 0, 0 | 100, 10, 50, 100, 0 | 100, 100, 20, 100, 80 |
| | H130R and C-105 | corrugated | | 2 | 20, 5, 80, 90, 90 | 100, 80, 100, 100, 40 | 100, 90, 100, 100, 15 |
| | each 10%; AC573 | cardboard | 350 | 1 | 0, 20, 70, 40, 5 | 0, 30, 0, 50, 0, 0 | 80, 20, 10, 100, 20 |
| | 5%; RT2304, 10% | | | 2 | 20, 0, 0, 90, 0 | 90, 100, 0, 5, 50 | 70, 20, 0, 50, 0 |
| 2558-83-35 | Terpolymer, 75% | Coated | 325 | 1 | 0, 100, 100, 0, 100 | 0, 100, 0, 0, 100 | 100, 100, 100, 50, 30 |
| | H130R, 10% | corrugated | | 2 | 0, 50, 90, 90, 90 | 10, 90, 90, 100, 20 | 100, 100, 100, 100, 100 |
| | C-105, 10% | cardboard | 350 | 1 | 0, 0, 0, 0, 0 | 0, 0, 0, 5, 0 | 0, 0, 100, 0, 0 |
| | AC596, 5% | | | 2 | 0, 0, 0, 0, 0 | 0, 100, 0, 0, 0 | 90, 0, 90, 5, 10 |
| Technomelt | Based on EVA + | Coated | 325 | 1 | 50, 0, 20, 100, 100 | 80, 80, 70, 100, 10 | 60, 80, 90, 0, 50 |
| 2697 | tackifier(s) + | corrugated | | 2 | 0, 90, 90, 60, 0 | 100, 0, 90, 95, 90 | 80, 100, 90, 95, 60 |
| | wax(es) | cardboard | 350 | 1 | 80, 100, 100, 50, 100 | 30, 80, 80, 10, 90 | 80, 90, 5, 10, 100 |
| | | | | 2 | 100, 100, 80, 100, 100 | 100, 100, 80, 100, 5 | 100, 100, 100, 100, 100 |

In the tests reported, above, the laminates were made using a Waldorf Bond Simulator (WBS). Three commercially available adhesives of the prior art were used as external controls while the other six adhesives were formulated using low and high MW lab-made terpolymers and various tackifiers and waxes, and for one sample, a maleic anhydride-grafted APAO. The laminates were made from strips cut from the flaps of corrugated cardboard boxes for commercial diapers and bonded together with hot melt adhesive. One half of the laminate (a strip) was 4 inches long and the other half, six inches long. Both strips were 1-inch wide.

The only instrumental variables were the dwell time (a.k.a., “open time”), end the melt temperature. The delay time was kept constant at 0.5 sec., while the compression was kept constant at 40 psi and the line speed was 120 fpm. The Nordson's nozzle orifice size of the WBS was also kept constant at 0050 inch while the nozzle tip-to-substrate distance was ⅜ inch. The length of the adhesive bead was set at 3.5 inch.

The laminates were divided into three sets and then conditioned at room temperature, at −20° F., and at 140° F. for 24 hrs. each. The laminates were then manually torn to subjectively determine the percent fiber tear. A total debonding of one strip from the other with no fiber tear was assigned a rating of 0%, while total fiber tear was rated as 100%.

Although particular embodiments of the present invention have been shown and described, they are not intended to limit what this patent covers. One skilled in the art will understand that various changes and modifications may be made without departing from the scope of the present invention as literally and equivalently covered by the following claims. What is claimed is:

1. A hot-melt adhesive comprising:
a) an APAO terpolymer;
b) a tackifier;
c) a wax component;
d) a component selected from the group consisting of maleic anhydride grafted polyethylene waxes, maleic anhydride grafted polypropylene waxes, and low molecular weight polymers; and,
e) a liquid plasticizer.

2. The hot-melt adhesive recited in claim 1 wherein the terpolymer has a melt viscosity of about 1000 cps to about 10,000 cps.

3. The hot-melt adhesive recited in claim 1 wherein the tackifier comprises a partially hydrogenated synthetic hydrocarbon tackifier.

4. The hot-melt adhesive recited in claim 1 wherein the tackifier comprises a fully hydrogenated synthetic hydrocarbon tackifier.

5. The hot-melt adhesive recited in claim 1 wherein the low molecular weight polymers are grafted with maleic anhydride.

6. The hot-melt adhesive recited in claim 1 wherein the wax component comprises a paraffinic wax.

7. The hot-melt adhesive recited in claim 1 wherein the wax component comprises a metallocene wax.

8. The hot-melt adhesive recited in claim 1 where in the liquid plasticizer comprises a mineral oil.

9. The hot-melt adhesive recited in claim 1 where in the liquid plasticizer comprises paraffinic oil.

10. The hot-melt adhesive recited in claim 1 wherein the APAO terpolymer is made in the presence of an externally-added organosilicon donor.

11. The hot-melt adhesive recited in claim 10 wherein the externally-added organosilicon donor is cyclohexylmethyl dimethoxy silane.

12. The hot-melt adhesive recited in claim 10 wherein the externally-added organosilicon donor is phenyl triethoxysilane.

13. The hot-melt adhesive recited in claim 1 wherein the APAO terpolymer comprises at least one ethylene-co-propylene-co-butene-1 terpolymer.

14. The hot-melt adhesive recited in claim 13 wherein the APAO terpolymer has a 1-butene content of between about 10% and about 25% by weight.

15. The hot-melt adhesive recited in claim 13 wherein the APAO terpolymer has an ethylene content of between about 5% to about 20% by weight.

16. The hot-melt adhesive recited in claim 13 wherein the APAO terpolymer has an ethylene content of between about 5% to about 10% by weight.

17. The hot-melt adhesive recited in claim 1 wherein the APAO terpolymer consists of ethylene-co-propylene-co-butene-1 terpolymer.

18. The hot-melt adhesive recited in claim 1 wherein the tackifier comprises a partially hydrogenated C₅ compound.

19. The hot-melt adhesive recited in claim 1 wherein the tackifier comprises a fully hydrogenated C₅compound.

20. The hot-melt adhesive recited in claim 1 wherein the tackifier comprises a hydrogenated dicyclopentadiene-type resin.

21. The hot-melt adhesive recited in claim 1 further comprising a hydrogenated styrene block copolymer.

22. The hot-melt adhesive recited in claim 1 further comprising a polyethylene polymer.

23. The hot-melt adhesive recited in claim 22 wherein the polyethylene polymer is a branched low density polymer having a melt index greater than about 500 dg/min.

24. The hot-melt adhesive recited in claim 1 further comprising a metallocene polyethylene polymer.

25. The hot-melt adhesive recited in claim 1 further comprising a metallocene polypropylene polymer.

26. The hot-melt adhesive recited in claim 1 wherein the tackifier comprises between about 0 and about 25% by weight of the hot melt adhesive, the wax component comprises about 0 to about 15% by weight of the hot melt adhesive and the liquid plasticizer comprises between 0 to about 25% by weight of the hot melt adhesive.
